(19) United States
(12) Patent Application Publication
(10) Pub. No.: US 2004/0086644 A1
(43) Pub. Date: May 6, 2004

(54) Local decorating of rough surfaces

(76) Inventor: Werner Frohnert, Detmold (DE)

Correspondence Address: DUANE MORRIS, LLP, IP DEPARTMENT, ONE LIBERTY PLACE, PHILADELPHIA, PA, 19103-7396, US

(21) Appl. No.: 10/466,017

(22) PCT Filed: Dec. 24, 2001
(86) PCT No.: PCT/EP01/15304

(30) Foreign Application Priority Data
Jan. 10, 2001 (DE) 101 00 828.7

(51) Int. Cl. B05D 5/00

(52) U.S. Cl. 427/256

(57) ABSTRACT

The invention relates to a method for producing functional objects (15, 10) that have a high-grade surface. The invention also relates to a functional object that is produced according to said method. The aim of the invention is to simplify the production method, whereby the surface of the objects should be finished in a cost-effective manner while still obtaining a high-quality effect for e.g. an advertising medium or an object of art. To begin with, the functional object has, at least in areas, at least one glazed or milky dull surface (13) that serves as a characteristic surface. This characteristic surface (13) is, essentially throughout or in an all-over manner, of the same character inside the area (15a, 20b), in which a decoration or marking (25, 20) should ensue. The decoration or marking (20, 25; 20a) is made by applying a fluid to the characteristic surface (13) in order to smoothen the surface into the shape or form (20a) of the decoration or marking.

The invention relates to a method for producing objects of utility having a noble surface. It also relates to an object that is produced in accordance with such a method, which object may be produced by said method but also claims protection of its own (independently of said method).

Satined surfaces are nobly appearing surfaces of objects of utility. In refining glass, glass objects are used, the surface of which is satined or made milky dull in order to obtain said particularly high-grade and noble effect of the surface. The glass being milky dull at the surface is obtained by means of an etching process. For this purpose a clear, transparent glass object, such as a mug or a writing instrument, or any other object of utility, such as a cup, bottle, vase or picture-frame, is immersed in an etching fluid reacting with the surface of the object of utility. The result is an outer surface of the glass object having a high surface roughness and a cratered configuration, when viewed in detail. By that means incident light is refracted, cannot pass through the glass object and the surface appears dull, milky or satined. However, the inner surface of the glass container remains perfectly smooth. If treatment of the surface is omitted in several places, i.e. the glass object is not contacted by the etchant in said places or is covered to this extent, the surface will not be roughened in said places, but remains crystal clear just as the opposing surface. However, all places contacted by the etchant will become dull. In this way a marking or decoration, such as a lettering in the sense of an advertising slogan, a company name or a pattern, may be applied having a particularly high-grade, noble effect due to the contrast of a milky white environment and a crystal clear, transparently appearing lettering or pattern.

It is the object of the invention to simplify a production method of the kind mentioned at the beginning, in which the surface of objects is to be refined in such a manner that the same high-grade and noble effect is achieved for e.g. an advertising medium or object of art, however, wherein costs of the production method are to be lowered, while simultaneously providing flexibility, versatility and easy adaptability to various optical designs of the decorations or markings, in particular writings.

This is achieved by a method, which starts from a completely satined or milky dull surface of the glass object, at least in that region, which is to carry the lettering. The region being greater than the marking, preferably comprising the entire surface of the object of utility made of glass. The decoration or marking is placed into this region, wherein a fluid is applied, which makes the milky dull surface at the site of application become again a smooth surface.

If the fluid is translucent, the crystal-clear, transparent surface is created only in those places where the decoration is actually located, i.e. for example in the form of the writing. The satined or dull (referred to as characteristic in the following) surface is thus changed in this region, though the starting product is already completely satined in the region of application so that the satining is neutralized in the region of the lettering.

Contrary to the prior art, during satining a certain region is not spared, which region will subsequently form the decoration or marking, the surface is rather at first completely and thus simplified refined by means of a dull structure, and said dull surface is only partially reconverted to a smooth surface, e.g. by silk screen printing or pad printing, by means of which the fluid adhering to the surface defines (locally restricted) the form and shape of the decoration.

The fluid may be a quartz fluid (claim 2). The object of utility made of glass, which is produced by said method, is provided with a boundary layer at the site of the covering, which boundary layer is located between the cured fluid and the glass surface (claim 14).

If the opposing surface is transparent and if the fluid as a quartz fluid is also translucent, a crystal-clear, transparent effect is achieved, when a ray of light impinges perpendicularly onto the imprinted marking, which effect is not present outside the marking or decoration. The marking or decoration becomes glassy having a smooth surface, while the surroundings appear satined dull causing the noble character without creating problems in the production method and without having to take the decoration into account already during satining.

By use of two different methods, the etching method for satining and the printing method for restricted compensation of the satining at the site of the writing, the lettering is facilitated and thus also the production of the objects of utility. Versatility may be substantiated, wherein the satined surfaces are produced in one place (at the manufacturer of the glass object) and supplied as prefabricated products, while only at the second enterprise the definition of the marking or decoration is selected, placed and thus realized.

It should be emphasized that the coating by means of the fluid, which adheres to the surface and dries or cures subsequently, will not necessarily yield a transparent marking or decoration, the invention rather also includes a surface having a different structure, e.g. a colored or opaque surface, provided it is substantially smooth compared to the satined surface in the marginal region around the lettering and in the residual region surrounding it.

The residual region is referred to as area or all-over area, whereas the selective region is the region of the marking, decoration, especially lettering. The all-over area does not necessarily have to cover the entire object (the object of utility), it may rather cover a portion thereof, which is, however, greater than the marking or decoration.

The fluid together with the predetermined printing method determines the form of the decoration or marking. Other variants of application may also be employed so far as they allow a restriction of the (greater) partial areas to be coated, which restriction may be predetermined or fixed (locally).

The decoration is applied—according to the production method—only after the satining (claim 5). The pre-satined glass objects may be stored and provided with specific writings or decorations, if required and according to customer's need.

The back, i.e. the opposing surface of the wall of the glass object, which carries the satining and the smooth decoration on the outside, may also be optionally designed. It may be colored or imprinted.

The portions of the writing may comprise a different material than glass at the surface as an option of a marking or decoration (claim 12), whereas outside of the decoration there remains the etched, cratered surface (claim 11). The effect of a crystal-clear writing is particularly advantageous, if the opposing side of the surface is transparent and smooth and the decoration applied by printing is also smooth at its surface, while the satined surface prevails outside the decoration (claim 8).

Embodiments will explain and supplement the invention.

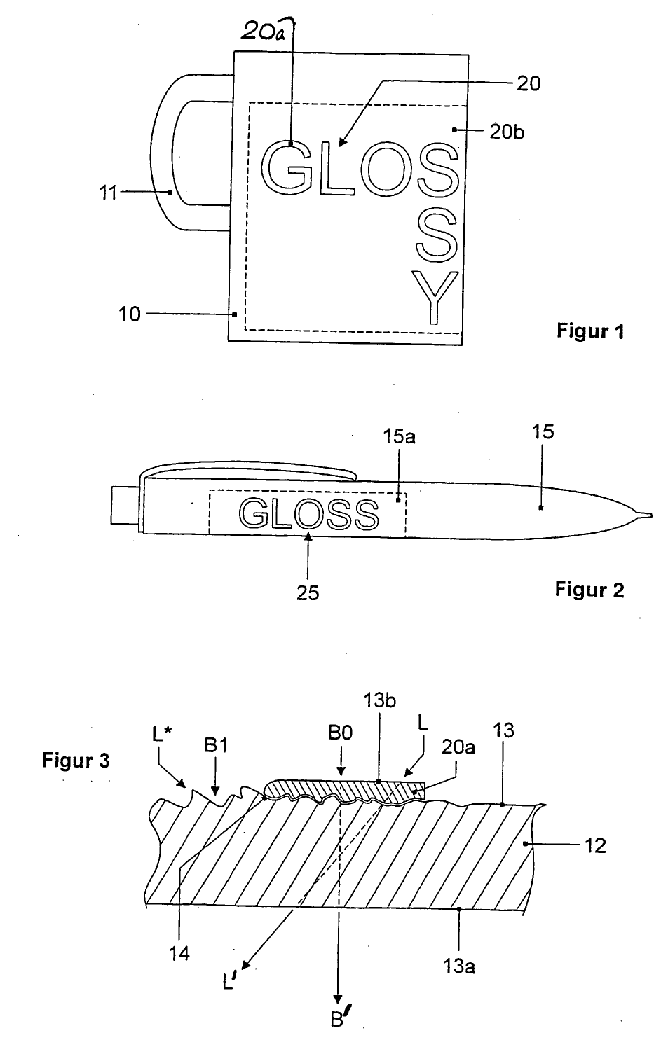

FIG. 1 is a side view of a mug 10 having a handle.

FIG. 2 is a ball-point having a shaft 15.

FIG. 3 is an enlarged cut-out from a surface according to FIG. 1 or 2, wherein roughness 13 of the surface is illustrated greatly enlarged in order to emphasize the effect.

The cup shown in FIG. 1 has a substantially cylindrical surface. On said cylindrical surface a writing 20 is provided in region 20b to illustrate a marking or decoration. The surface structure outside the writing 20, the capital letter “G” of which is indicated by 20a, is satined or made milky white in the sense of a nontransparent (rough) surface. This surface is obtained by an etching method creating from the previously clear and completely transparent surface of the glass mug 10 a surface, which is translucent, however, not see-through. The surface appears dull and has a shape, which may be referred to as cratered as shown in the cross-section of FIG. 3 at 13.

As shown in FIG. 3, the surface 13 upon the glass wall 12, which is the mug wall of mug 10, is produced e.g. by means of hydrofluoric acid as the outer surface of the mug is immersed into an acid over a predetermined period of time and is thus etched at the surface.

The removed mug is fashioned substantially all-over at its surface as indicated by surface 13.

Lettering of the surface, in the sense of a decoration or marking, which may also be supplemented with any other logo, may be achieved by a printing method, in which the decoration or marking is imprinted on the cratered surface 13 of FIG. 3.

This method uses silk screen printing or pad printing, wherein a quartz fluid is used as the “printing ink”, which fluid can be seen as capital letter “G” at 20a in the cross-section of FIG. 3. By this application variant a fluid layer is imprinted in the form of letter “G”, surface 13 is made even at the printing site and a smooth surface 13b is formed. This smooth surface is translucent relating to a perpendicularly impinging glance B0, which passes completely through glass wall 12 if the opposing surface 13a is smooth. A transversely impinging ray of light L will be partly reflected and passes partly through in order to obtain transirradiated light ray L′.

In contrast to the writing region 13b, the region outside it is still cratered at the surface so that a glance B1 will not pass through wall 12, which surface, however, appears milky. A transversely impinging light ray L* will not be transirradiated, but illuminates the surface by scattering so that a milky color is created.

Opposing area 13a may additionally be coated if color effects or other transirradiation effects are desired.

The printing ink as a quartz fluid is selected such that it is as glass-like as possible. If another ink or dye is used or a nontransparent but opaque ink or dye is chosen, the difference between dull and clear may also define the design of the outer surface of mug 10. Under the influence of temperature drying or curing may be expedited.

Contrary to previous production methods the twice treated places are crystal clear or smooth, while said places were the untreated places in the prior art. Those places outside the marking having been treated once by an etching method are similar. By the printing method an intermediate layer 14 is formed between the quartz fluid 20a and the uneven surface 13, which intermediate layer serves as a link for exerting adhesive forces on the imprinted marking symbols.

Instead of a mug 10 also other objects of utility, such as glasses, vases, mirrors or pots as well as bottles, may be used. It is even possible to use writing instruments according to FIG. 2, which need not necessarily be made of glass. They may be made of a glass-like plastic material being substantially translucent, wherein a region 15a is determined, in which the marking 25 is to be applied. Only this region needs to be satined, if the contrast between rough (dull) and smooth (writing 25) is to stand out.

Instead of the restricted region 15a also the whole writing instrument 15 may be satined at the shaft, wherein the remaining components of the writing instrument (clip and push button as well as writing tip) need not be explained separately.

I claim:

1. Method for producing surface structures on an object of utility (15, 10), in which method said object of utility comprises, at least in regions, a satined or milky dull surface (13) as a characteristic surface, wherein
(a) said satined or dull (characteristic) surface (13) is, substantially throughout or all-over, of the same character in region (15a, 20b), in which a decoration or marking (25, 20), in particular a writing, is to be effected,
(b) said decoration or marking (20, 25; 20a) is produced in region (15a, 20b) by applying a fluid onto said characteristic surface (13) in order to make the surface even within a form or shape (20a) of said decoration or marking.

2. Method as claimed in claim 1, wherein said fluid is a quartz fluid.

3. Method as claimed in claim 1 or 2, wherein said fluid is curing, especially self-curing, preferably also under the influence of temperature.

4. Method as claimed in any one of the preceding claims, wherein said fluid is applied in the form of said decoration or marking (20, 20a) by a silk screen printing method or pad printing method.

5. Method as claimed in any one of the preceding claims, wherein said decoration (20a) is applied to the surface of said object of utility (15, 10) later than said satining (13).

6. Method as claimed in claim 1, wherein said satining or provision of a milky dull surface (13) of said object of utility is achieved by an etching process, wherein said object of utility is made of glass, at least in the region of treatment.

7. Method as claimed in claim 1 or 6, wherein said object of utility is comprised substantially completely of glass or a glass-like material.

8. Method as claimed in any one of the preceding claims, wherein said marking or decoration is crystal clear, in particular transparent and essentially completely see-through, after application to said satined or dull (characteristic) surface (13), whereas the surface outside of said decoration (20a) remains dull and substantially nontransparent.

9. Method as claimed in claim 1, wherein said marking or decoration is a writing.

10. Method as claimed in claim 1, wherein a plurality of said objects of utility having a characteristic surface without a marking or decoration in the region to be decorated are supplied and said supplied objects are subsequently imprinted with said marking or decoration in region (15a, 20b) in a printing method in order to obtain a refined object of utility.

11. Method as claimed in any one of the preceding claims, wherein a cratered surface (13) in the characteristic region becomes a smooth surface by means of a printing method, wherein said smooth surface (13b) determines said marking or decoration, in particular a writing, of said object of utility.

12. Method as claimed in claim 1, wherein said marking (20a) or decoration is comprised of a different material than said surrounding region (13) in the region of the surface of said object of utility.

13. Handy object of utility produced or producible according to any one of the preceding claims, in particular a jug or cup.

14. Object of utility as claimed in claim 13, wherein a boundary layer (14) is formed between said marking or decoration (20a) and an uneven surface below said decoration, which boundary layer has an adhesive effect.

15. Method for producing surface structures on an object (15, 10) having a glasslike wall (12),
in which method said object is provided, at least in regions, with a satined, rough or milky dull surface (13) as a characteristic surface,
wherein said, at least in regions, characteristic surface (13) is, substantially throughout or all-over, of the same character,
wherein a decoration (20, 25, 20a) is produced by applying a fluid, extending in the direction of the surface in a restricted and defined manner, onto and into said characteristic surface (13) in order to smoothen said surface within a shape (20a) of said decoration.
